(19) United States
(12) Patent Application Publication
(10) Pub. No.: US 2018/0019815 A1
(43) Pub. Date: Jan. 18, 2018

(54) METHOD AND DEVICE FOR ESTIMATING TRANSMISSION QUALITY OF OPTICAL PATH

(71) Applicant: FUJITSU LIMITED, Kawasaki-shi (JP)

(72) Inventor: MASATAKE MIYABE, Kawasaki (JP)

(73) Assignee: FUJITSU LIMITED, Kawasaki-shi (JP)

(21) Appl. No.: 15/609,976

(22) Filed: May 31, 2017

(30) Foreign Application Priority Data
Jul. 14, 2016 (JP) 2016-139348

(51) Int. Cl. H04B 10/079; H04Q 11/00

(52) U.S. Cl. CPC H04B 10/07957; H04Q 11/0066; H04Q 2011/0079; H04Q 2011/0016

(57) ABSTRACT

A transmission quality estimation method estimates a transmission quality of a target path. The method includes: storing path transmission quality values that respectively indicate transmission qualities of paths established between adjacent nodes in a first storage; storing a node transmission quality value that indicates a transmission quality of a node device in a second storage; estimating a transmission quality of the target path based on the path transmission quality values stored in the first storage and the node transmission quality value stored in the second storage; calculating the node transmission quality value based on the estimated transmission quality of the target path; and updating the node transmission quality value stored in the second storage using the calculated node transmission quality value.

### CROSS-REFERENCE TO RELATED APPLICATION

This application is based upon and claims the benefit of priority of the prior Japanese Patent Application No. 2016-139348, filed on Jul. 14, 2016, the entire contents of which are incorporated herein by reference.

### FIELD

The embodiments discussed herein are related to a method and a device for estimating a transmission quality of an optical path in an optical transmission system.

### BACKGROUND

When a request to establish a new wavelength path has been made in a wavelength division multiplexing optical transmission system, a network management system estimates a transmission quality of the requested wavelength path. Then, when the estimated transmission quality of the requested wavelength path is better than a specified threshold, the network management system establishes the requested wavelength path.

For example, the network management system includes a database that stores transmission quality information that indicates transmission qualities of a node device and a transmission link. In this case, the network management system reads transmission quality information corresponding to a route of the requested wavelength path from the database and calculates a transmission quality of the requested wavelength path. Here, the transmission qualities of a node device and a transmission link are determined, for example, according to the specification information provided by vendors of the node device and the optical fiber. However, there is a variation in the actual transmission qualities of a node device and an optical fiber. Thus, there is a need to provide a margin when a transmission quality of a wavelength path is estimated and a decision of whether transmission is possible is performed.

As a related technology, a method is proposed that includes calculating, for all of the routes selectable for end-to-end, an OSNR index value in which a quality of a transmission link is reflected and establishing a wavelength path on a route with an optimal transmission quality (for example, Japanese Laid-open Patent Publication No. 2007-82086).

However, it is not easy to appropriately estimate a margin for estimating a transmission quality of a wavelength path and deciding whether transmission is possible. If the margin is too small, there is a possibility that a desired transmission quality will not be obtained in a wavelength path on which a decision that transmission is possible has been made. Conversely, if the margin is too large, too much equipment (such as a repeater arranged in an optical transmission link) will be arranged, which results in extra costs.

### SUMMARY

According to an aspect of the present invention, a transmission quality estimation method estimates a transmission quality of a target path. The method includes: storing path transmission quality values that respectively indicate transmission qualities of paths established between adjacent nodes in a first storage; storing a node transmission quality value that indicates a transmission quality of a node device in a second storage; estimating a transmission quality of the target path based on the path transmission quality values stored in the first storage and the node transmission quality value stored in the second storage; calculating the node transmission quality value based on the estimated transmission quality of the target path; and updating the node transmission quality value stored in the second storage using the calculated node transmission quality value.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 illustrates an example of an optical transmission system;

FIG. 2 illustrates an example of a node device;

FIG. 3 illustrates an example of a configuration of a wavelength path;

FIG. 4 is a flowchart that illustrates an example of a method for estimating a transmission quality of a wavelength path;

FIG. 5 illustrates an example of a measurement system that measures a transmission quality in a node device;

FIG. 6 illustrates an example of measuring a transmission quality between adjacent nodes;

FIG. 7 illustrates an example of a transmission quality database;

FIG. 8 illustrates the transmission quality database to which data corresponding to a new wavelength path has been added;

FIG. 9 illustrates an example of a transmission quality estimation device;

FIG. 10 illustrates an example of a transmission quality database;

FIG. 11 illustrates an example of a method for calculating an intra-node OSNR;

FIG. 12 is a flowchart that illustrates an example of the transmission quality estimation method;

FIG. 13 illustrates the transmission quality database to which data corresponding to a new wavelength path has been added; and

FIG. 14 illustrates an example of a hardware configuration of the transmission quality estimation device.

### DESCRIPTION OF EMBODIMENTS

In a transmission quality estimation method according to embodiments of the present invention, a transmission quality of an already established wavelength path is measured in advance. Then, using the measurement value, a transmission quality of a new wavelength path is estimated. For example, it is assumed that a wavelength path #1 is established between a node A and a node B, and a wavelength path #2 is established between the node B and a node C. Here, a transmission quality of each of the wavelength paths #1 and #2 has been measured. Then, when a new wavelength path #3 is requested between the node A and the node C via the node B, a transmission quality estimation device estimates a transmission quality of the wavelength path #3 according to the transmission quality of the wavelength path #1 and the transmission quality of the wavelength path #2. As a result, if the estimated transmission quality is better than a specified threshold, a network control system will establish the wavelength path #3.

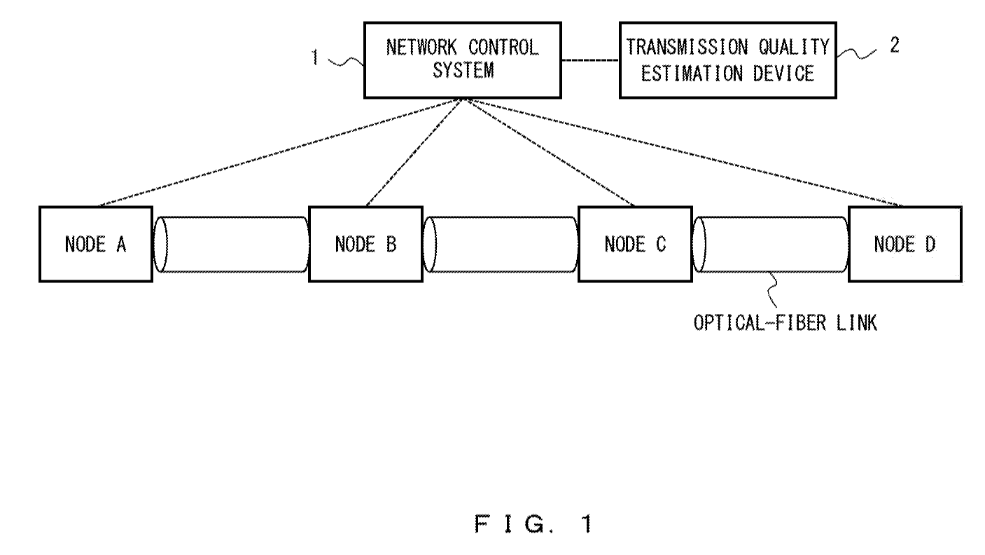

FIG. 1 illustrates an example of an optical transmission system according to the embodiments of the present invention. In the example illustrated in FIG. 1, a connection between a node A and a node B, a connection between the node B and a node C, and a connection between the node C and a node D are each established by a respective optical-fiber link.

The optical transmission system transmits a wavelength division multiplexed optical signal (hereinafter referred to as a WDM optical signal) between nodes. Thus, each node is provided with a WDM transmission device. The WDM transmission device is implemented by, for example, a reconfigurable optical add-drop multiplexer (ROADM).

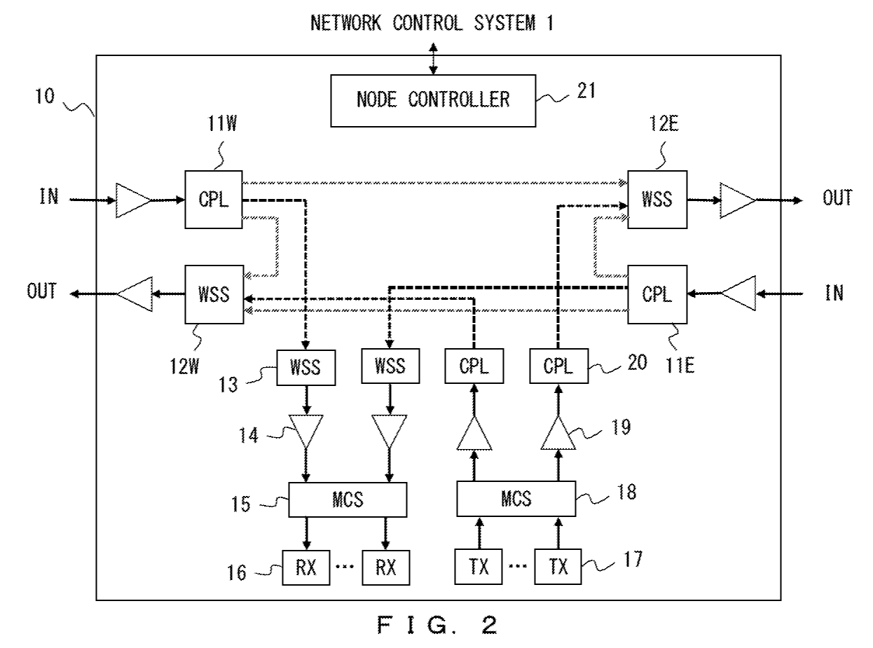

FIG. 2 illustrates an example of a node device. A node device (in this example, a ROADM) 10 includes optical splitters 11W and 11E, wavelength selective switches 12W and 12E, wavelength selective switches 13, optical amplifiers 14, a multicast switch 15, receivers 16, transmitters 17, a multicast switch 18, optical amplifiers 19, optical couplers 20, and a node controller 21.

The optical splitter (CPL) 11W guides a WDM optical signal received through a west degree circuit to the wavelength selective switch 12E, the wavelength selective switch 13, and the wavelength selective switch 12W. The optical splitter (CPL) 11E guides a WDM optical signal received through an east degree circuit to the wavelength selective switch 12W, the wavelength selective switch 13, and the wavelength selective switch 12E. The wavelength selective switch 12W selects an optical signal of a specified wavelength from optical signals guided from the optical splitter 11E, the optical coupler 20, and the optical splitter 11W. The wavelength selective switch 12E selects an optical signal of a specified wavelength from optical signals guided from the optical splitter 11W, the optical coupler 20, and the optical splitter 11E.

Each of the wavelength selective switches 13 selects an optical signal of a specified wavelength from the WDM optical signal guided from the optical splitter 11W,11E. The optical amplifier 14 amplifies the optical signal selected by the wavelength selective switch 13. The multicast switch 15 guides the optical signal amplified by the optical amplifier 14 to a receiver 16 that corresponds to a specified client. Each of the receivers 16 demodulates the received optical signal so as to recover data.

Each of the transmitters 17 generates an optical signal that transmits client data. The multicast switch 18 guides the optical signal output from the transmitter 17 to a degree that corresponds to the destination of the optical signal. The optical amplifier 19 amplifies the optical signal output from the multicast switch 18. The optical coupler 20 guides the optical signal amplified by the optical amplifier 19 to the wavelength selective switch 12E,12W.

The node controller 21 controls an operation of the node device 10 according to an instruction given by a network control system 1. For example, according to the instruction received from the network control system 1, the node device 10 can drop an optical signal of a desired wavelength from a received WDM optical signal and guide the dropped optical signal to a client. Further, the node device 10 can also add client data to a WDM optical signal. Furthermore, the node device 10 can also guide an optical signal of a desired wavelength in a WDM optical signal received through a certain degree circuit to another degree circuit without dropping the desired optical signal. In other words, the node device 10 can “drop”, “add”, or “through (guide without dropping)” for each wavelength.

The network control system 1 is connected to each node. The network control system 1 instructs each node device 10 to establish, delete, or change a wavelength path. When the network control system 1 establishes a new wavelength path, a transmission quality estimation device 2 estimates a transmission quality of the new wavelength path. When an estimated value of the transmission quality of the wavelength path is better than a specified threshold, the network control system 1 establishes the wavelength path. On the other hand, when the estimated value of the transmission quality is worse than the specified threshold, the network control system 1 searches for another route.

When the transmission quality estimation device 2 estimates a transmission quality of a wavelength path, the transmission quality estimation device 2 uses a transmission quality of each span on a route on which the wavelength path is established and uses a transmission quality of a node device. Thus, the spans that configure a wavelength path and the node device are described before an operation of the transmission quality estimation device 2 is described.

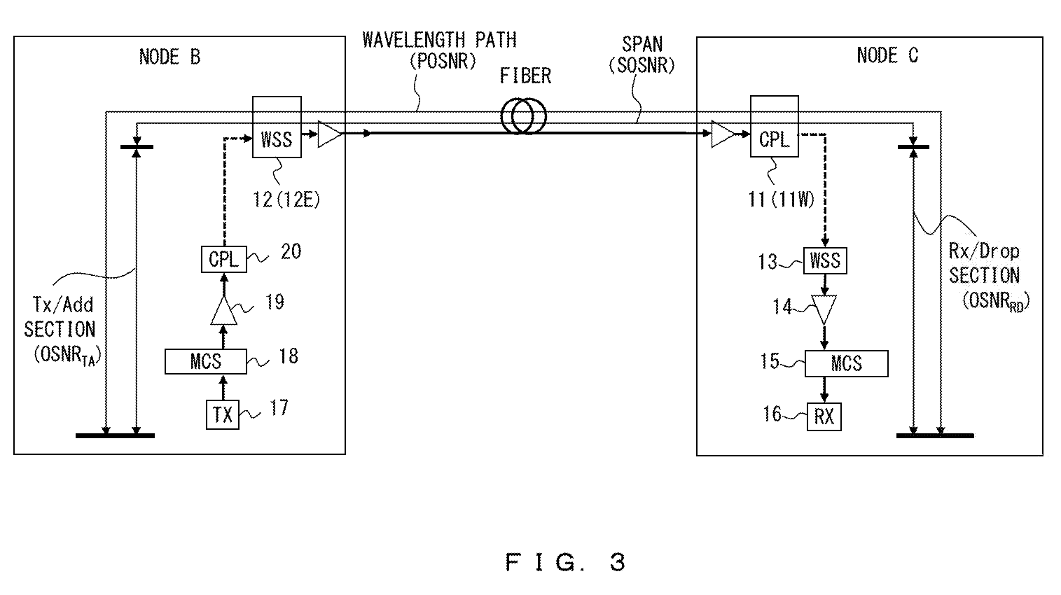

FIG. 3 illustrates an example of a configuration of a wavelength path. Here, a wavelength path is established over which an optical signal is transmitted from the transmitter 17 accommodated in the node B to the receiver 16 accommodated in the node C. In this case, this wavelength path can be divided into the following three sections.

(1) Tx/Add section
(2) Span section
(3) Rx/Drop section

The Tx/Add section corresponds to a route through which an optical signal added to a WDM optical signal in the node B passes. In other words, the Tx/Add section includes the transmitter 17, the multicast switch 18, the optical amplifier 19, and the optical coupler 20 in the node B. The span section corresponds to a route through which an optical signal added in the node B is multiplexed in a WDM optical signal and transmitted to the node C. In other words, the span section includes the wavelength selective switch 12, the optical-fiber link between the nodes B and C, and the optical splitter 11. The Rx/Drop section corresponds to a route through which an optical signal dropped from a WDM optical signal in the node C passes. In other words, the Rx/Drop section includes the wavelength selective switch 13, the optical amplifier 14, the multicast switch 15, and the receiver 16 in the node C.

Thus, in the example illustrated in FIG. 3, POSNR_{B-C} that represents an OSNR of a wavelength path is represented by Formula (1).

$$\frac{1}{{POSNR}_{B - C}} = \frac{1}{{SOSNR}_{B - C}} + \frac{1}{{OSNR}_{TA}} + \frac{1}{{OSNR}_{RD}} \qquad ( 1 )$$

SOSNR_{B-C} represents an OSNR of a span between the nodes B and C. OSNR_{TA} represents an OSNR of the Tx/Add section in the node B. OSNR_{RD} represents an OSNR of the Rx/Drop section in the node C.

The OSNRs of the Tx/Add section and the Rx/Drop section are represented by Formula (2).

$${OSNR}_{adtr} = \frac{1}{\frac{1}{{OSNR}_{TA}} + \frac{1}{{OSNR}_{RD}}} \qquad ( 2 )$$

Then, a span OSNR between the nodes B and C (that is, SOSNR_{B-C}) is represented by Formula (3).

$${SOSNR}_{B - C} = \frac{1}{\frac{1}{{POSNR}_{B - C}} - \frac{1}{{OSNR}_{adtr}}} \qquad ( 3 )$$

OSNR_{adtr} corresponds to an OSNR in a node device. In the following descriptions, the OSNR in a node device may be referred to as an “intra-node OSNR” or a “node transmission quality value”. Further, the OSNR of a span between adjacent nodes (that is, an OSNR of one span section) may be referred to as a “span OSNR”. Furthermore, the OSNR of a wavelength path (that is, an OSNR from a transmitter to a receiver) may be referred to as a “path OSNR”.

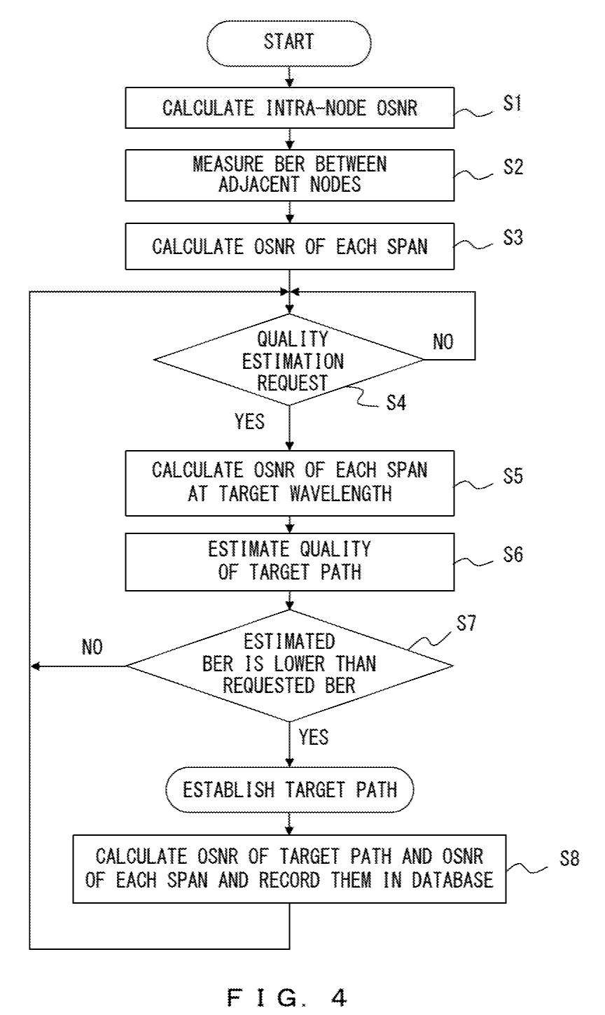

FIG. 4 is a flowchart that illustrates an example of a method for estimating a transmission quality of a wavelength path. The processing of this flowchart is performed, for example, when a request to establish a new wavelength path has been made.

In S1, the transmission quality estimation device 2 calculates an intra-node OSNR (that is, OSNR_{adtr}). Here, the OSNR can be calculated according to a bit error rate using Formula (4). BER represents a bit error rate. Rs represents a baud rate of a signal. Bn represents a noise bandwidth. It is assumed that the bit rate is 100 Gbps and a polarization-multiplexed QPSK-modulated optical signal is transmitted.

$$OSNR = {( {erfc}^{- 1} ( 2 BER ) )}^{2} \cdot \frac{2 Rs}{Bn} \\ erfc ( x ) = \frac{2}{\sqrt{π}} {\int }_{x}^{∞} {e}^{- {t}^{2}} dt \qquad ( 4 )$$

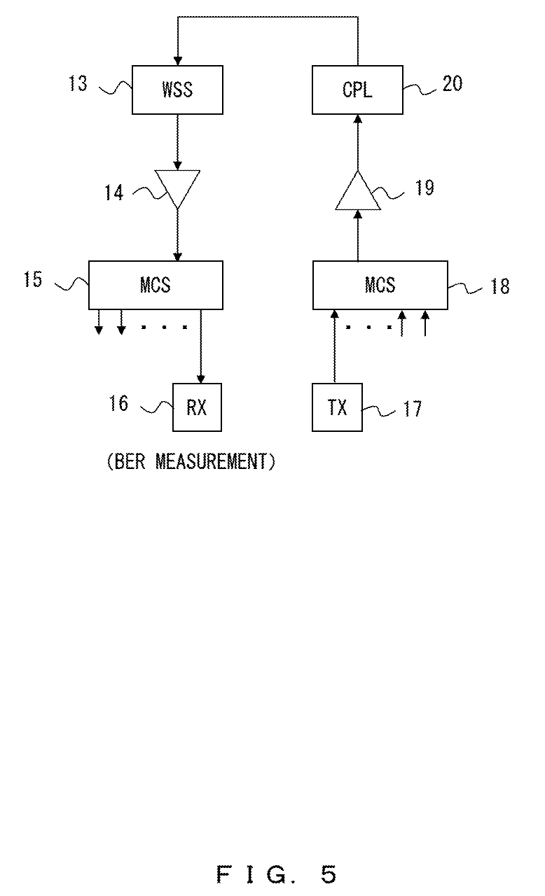

Thus, the transmission quality estimation device 2 obtains a measurement value of a bit error rate in a node device. For example, the bit error rate in a node device is measured in one node device using a measurement system illustrated in FIG. 5. In this case, an optical signal output from the transmitter 17 is guided to the receiver 16 via the optical coupler 20 and the wavelength selective switch 13. Then, the bit error rate is measured in the receiver 16. The transmission quality estimation device 2 calculates OSNR_{adtr}, which represents an intra-node OSNR, by providing the measurement value of the bit error rate to Formula (4).

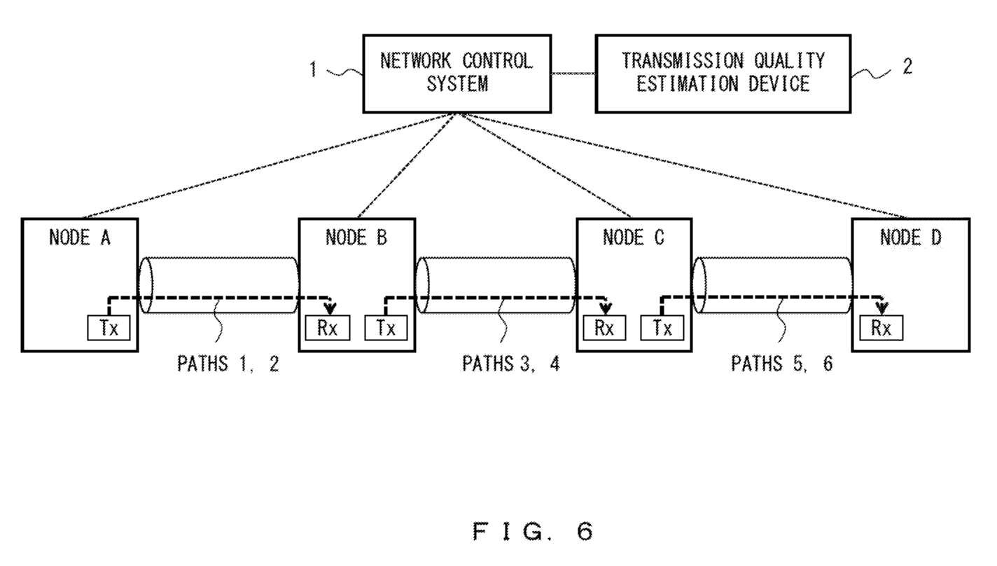

In S2, the network control system 1 measures a bit error rate of a wavelength path established between each set of adjacent nodes. In the example illustrated in FIG. 6, a wavelength path 1 and a wavelength path 2 are established between the nodes A and B, a wavelength path 3 and a wavelength path 4 are established between the nodes B and C, and a wavelength path 5 and a wavelength path 6 are established between the nodes C and D. An optical signal is transmitted over each of the wavelength paths, and a bit error rate is measured in each reception-side node. A measurement result is collected by the network control system 1 and provided to the transmission quality estimation device 2.

In S3, according to the bit error rate measured in each of the wavelength paths, the transmission quality estimation device 2 calculates OSNRs of the respective wavelength paths. Here, the bit error rate is converted into an OSNR using Formula (4). Further, the transmission quality estimation device 2 calculates an OSNR of each span (that is, SOSNR) using Formula (3). OSNR_{adtr} is calculated in S1. Then, an OSNR value of each span that is calculated in this way is recorded in a transmission quality database of the transmission quality estimation device 2.

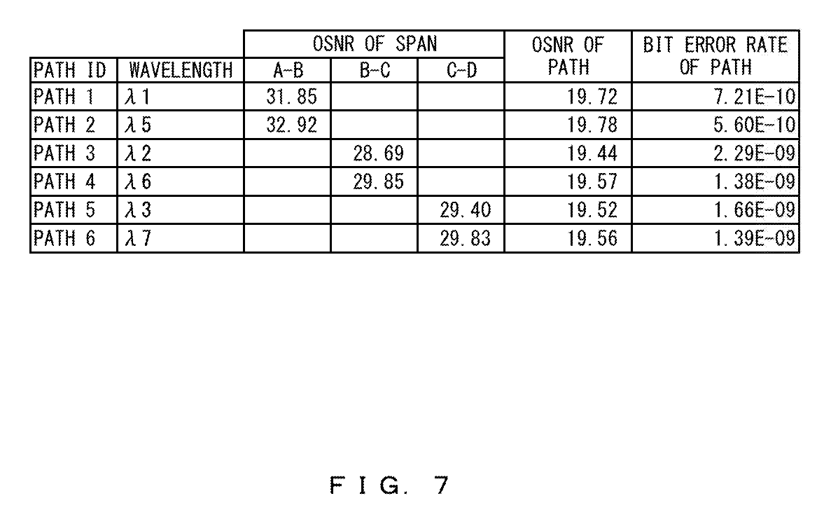

FIG. 7 illustrates an example of the transmission quality database. In this example, it is assumed that the wavelength path 1 and the wavelength path 2 are established between the nodes A and B, the wavelength path 3 and the wavelength path 4 are established between the nodes B and C, and the wavelength path 5 and the wavelength path 6 are established between the nodes C and D, as illustrated in FIG. 6. Wavelengths of the wavelength paths 1 to 6 are λ1, λ5, λ2, λ6, λ3, and λ7, respectively.

“BIT ERROR RATE OF PATH” represents a bit error rate measured for each wavelength path. “OSNR OF PATH” is calculated from the bit error rate using Formula (4). “OSNR OF SPAN” is calculated from intra-node OSNR_{adtr} calculated in S1 and “OSNR OF PATH”, using Formula (3).

The transmission quality of a wavelength path (or the transmission quality of a span) depends on the wavelength of a transmitted optical signal. In the example illustrated in FIG. 7, the OSNR of the wavelength λ5 is slightly better than the OSNR of the wavelength λ1. On the other hand, it is assumed that the intra-node transmission quality does not substantially depend on the wavelength of an optical signal.

In S4, the transmission quality estimation device 2 waits for a quality estimation request with respect to a new wavelength path. A demand for establishing a new wavelength path is provided to the network control system 1. In this case, the network control system 1 generates a quality estimation request according to the demand and transmits the request to the transmission quality estimation device 2. The quality estimation request specifies, for example, a start point node, an end point node, a route from the start point node to the end point node, and a wavelength of a wavelength path.

In this sample, it is assumed that the transmission quality estimation device 2 receives the following quality estimation request.

Start point: node A
End point: node D

### Route: A-B-C-D

### Wavelength: λ4

In the following descriptions, the wavelength path whose transmission quality is estimated according to the quality estimation request may be referred to as a “target path”.

In S5, the transmission quality estimation device 2 calculates an OSNR at a wavelength of a target path for each span on a route on which the target path is established. In other words, the span OSNR at the wavelength λ4 is calculated according to the OSNR recorded in the transmission quality database illustrated in FIG. 7. For example, the span OSNR at the wavelength λ4 between the nodes A and B is estimated by use of linear interpolation using Formula (5).

$${ESOSNR}_{A - B} ( λ 4 ) = \frac{{SOSNR}_{A - B} ( λ 1 ) - {SOSNR}_{A - B} ( λ 5 )}{λ 1 - λ 5} ( λ 4 - λ 5 ) + {SOSNR}_{A - B} ( λ 5 ) \qquad ( 5 )$$

ESOSNR_{A-B}(λ4) represents an estimated value of the span OSNR at the wavelength λ4 between the nodes A and B. SOSNR_{A-B}(λ1) represents a calculation value of the span OSNR at the wavelength λ1 between the nodes A and B. SOSNR_{A-B}(λ5) represents a calculation value of the span OSNR at the wavelength λ5 between the nodes A and B. SOSNR_{A-B}(λ1) and SOSNR_{A-B}(λ5) are recorded in the transmission quality database.

Similarly, the transmission quality estimation device 2 estimates the span OSNR at the wavelength λ4 between the nodes B and C (ESOSNR_{B-C}(λ4)) and the span OSNR at the wavelength λ4 between the nodes C and D (ESOSNR_{C-D}(λ4)).

In S6, the transmission quality estimation device 2 estimates the OSNR of the target path using Formula (6). In this example, the path OSNR of a wavelength path 7 over which an optical signal is transmitted from the transmitter 17 of the node A to the receiver 16 of the node D is estimated.

$${EPOSNR}_{A - D} ( λ 4 ) = \frac{1}{\begin{matrix}\frac{1}{{ESOSNR}_{A - B} ( λ 4 )} + \frac{1}{{ESOSNR}_{B - C} ( λ 4 )} + \\ \frac{1}{{ESOSNR}_{C - D} ( λ 4 )} + \frac{1}{{OSNR}_{adtr}}\end{matrix}} \qquad ( 6 )$$

EPOSNR_{A-D}(λ4) represents an OSNR of a wavelength path over which an optical signal is transmitted from the transmitter 17 of the node A to the receiver 16 of the node D.

Further, the transmission quality estimation device 2 calculates a bit error rate from the OSNR of the target path using Formula (7). In this example, it is assumed that the bit rate is 100 Gbps and a polarization-multiplexed QPSK-modulated optical signal is transmitted.

$${EPBER}_{A - D} ( λ 4 ) = \frac{1}{2} erfc ( \sqrt{\frac{{EPOSNR}_{A - D} ( λ4 ) \cdot Bn}{2 Rs}} ) \qquad ( 7 )$$

EPBER_{A-D}(λ4) represents an estimated bit error rate of a wavelength path over which an optical signal is transmitted from the transmitter 17 of the node A to the receiver 16 of the node D. Rs represents a baud rate of the signal. Bn represents a noise bandwidth.

In S7, the transmission quality estimation device 2 compares the transmission quality estimated in S6 and a specified threshold. In this example, the estimated bit error rate calculated in Formula (7) and a requested bit error rate are compared. Then, when the estimated bit error rate is lower than the requested bit error rate, the transmission quality estimation device 2 decides that the target path can be established. On the other hand, when the estimated bit error rate is higher than the requested bit error rate, the transmission quality estimation device 2 decides that the target path is not to be established. A result of this decision is reported from the transmission quality estimation device 2 to the network control system 1.

When the network control system 1 receives a decision result indicating “possible to establish” from the transmission quality estimation device 2, the network control system 1 establishes the target path in an optical network. Here, a necessary instruction is provided to each node by the network control system 1. Further, the network control system 1 measures a bit error rate of the established target path and reports the measurement result to the transmission quality estimation device 2.

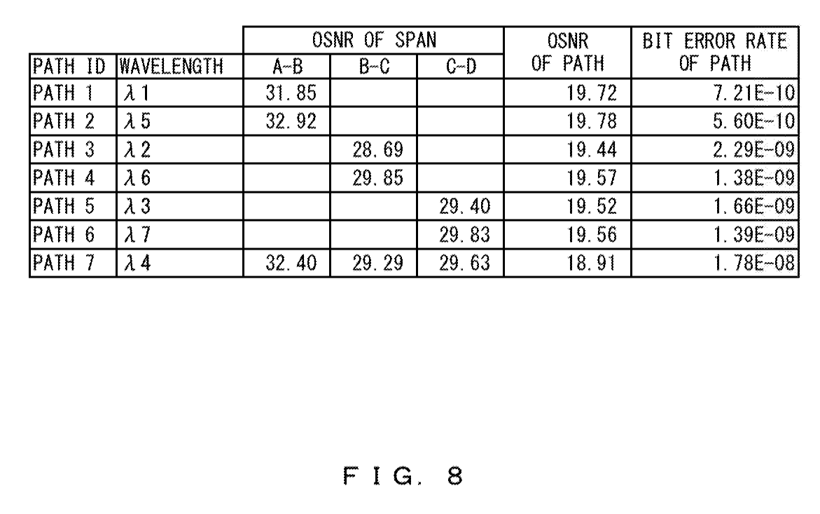

In S8, the transmission quality estimation device 2 records a measurement value of the bit error rate of the target path in the transmission quality database, as illustrated in FIG. 8. In FIG. 8, the target path is notated as “PATH 7”. Further, the transmission quality estimation device 2 calculates an OSNR of the target path from the measurement value of the bit error rate of the target path using Formula (8).

$${MPOSNR}_{A - D} ( λ4 ) = {( {erfc}^{- 1} ( 2 {MPBER}_{A - D} ( λ4 ) ) )}^{2} \cdot \frac{2 Rs}{Bn} \qquad ( 8 )$$

MPBER_{A-D}(λ4) represents a measurement value of a bit error rate of a target path established between the nodes A and D. MPOSNR_{A-D}(λ4) represents an OSNR of the target path that is calculated from the measurement value of the bit error rate of the target path. Then, the transmission quality estimation device 2 records the OSNR of the target path (that is, POSNR_{A-D}(λ4)) in the transmission quality database.

Further, the transmission quality estimation device 2 calculates a span OSNR at a wavelength of the target path for each span on a route on which the target path is established. Here, the OSNR of each span is calculated in S5. However, in S5, the OSNR of each span of the target path is estimated from an OSNR obtained in another wavelength path. In other words, the OSNR calculated in S5 includes an error. Thus, the transmission quality estimation device 2 calculates the OSNR of each span at the wavelength of the target path according to the measurement value of the bit error rate of the target path.

As an example, an error between the OSNR of the target path which is estimated from another wavelength path and the OSNR of the target path which is calculated according to the measurement value of the bit error rate of the target path is calculated. Then, the estimated value of the span OSNR that is obtained in S5 is corrected by use of the error for each span. For example, the span OSNR at the wavelength of the target path between the nodes A and B is calculated using Formula (9).

$${SOSNR}_{A - B} ( λ4 ) = \frac{1}{\frac{1}{{ESOSNR}_{A - B} ( λ4 )} + α ( \begin{matrix}\frac{1}{{POSNR}_{A - D} ( λ4 )} - \\ \frac{1}{{EPOSNR}_{A - D} ( λ4 )}\end{matrix} )} \qquad ( 9 )$$

SOSNR_{A-B}(λ4) represents the span OSNR at the wavelength λ4 between the nodes A and B. A coefficient α represents a proportion of an OSNR value between the nodes A and B to an OSNR value of the entirety of the target path.

Similarly, the OSNRs are also respectively calculated for the span between the nodes B and C and for the span between the nodes C and D. However, the coefficient α is determined by, for example, simulation for each span according to, for example, the features and the length of an optical-fiber link. The OSNRs of the spans are recorded in the transmission quality database for each span, as illustrated in FIG. 8.

As described above, an intra-node OSNR and an OSNR of each span are used in a method for estimating a transmission quality of a new wavelength path according to a transmission quality of an already established wavelength path. Here, in this example, the OSNR is calculated from a measurement value of a bit error rate. In other words, it is possible to estimate a transmission quality of a wavelength path established on a desired route by measuring a bit error rate of a wavelength path between each set of adjacent nodes and a bit error rate in a node device.

However, in many cases, a bit error rate in a node device is very small, and there is a large variation in measurement result for this bit error rate. If a transmission quality (here, an OSNR) of a target path is estimated according to the measurement result for a bit error rate in which there is a large variation, its estimation error will be made larger. As a result, there may be a decrease in an estimation accuracy of a transmission quality of a wavelength path. If the time period to measure a bit error rate is made longer, a variation in the bit error rate will be smaller. However, it is not realistic to measure a bit error rate over a long period of time in a network in operation.

Thus, the transmission quality estimation device according to the embodiments of the present invention is provided with a function that improves an estimation accuracy in a procedure for estimating a transmission quality of a new wavelength path according to a transmission quality of an already established wavelength path.

<Improvement of Estimation Accuracy>

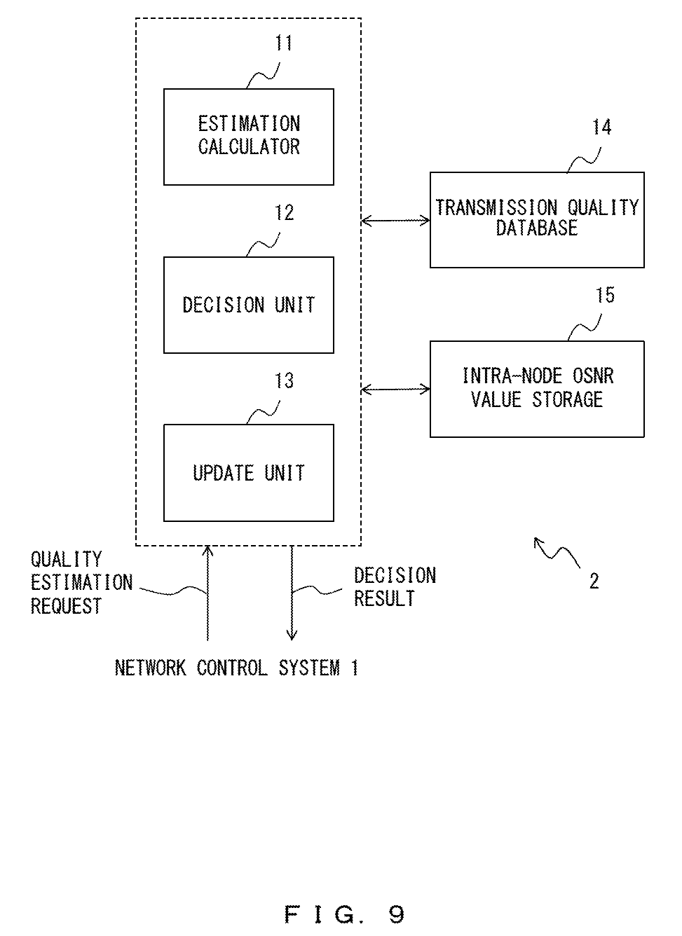

FIG. 9 illustrates an example of the transmission quality estimation device according to the embodiments of the present invention. As illustrated in FIG. 9, the transmission quality estimation device 2 includes an estimation calculator 11, a decision unit 12, an update unit 13, a transmission quality database 14, and an intra-node OSNR value storage 15. The transmission quality estimation device 2 may have any other functions not illustrated in FIG. 9. For example, the transmission quality estimation device 2 may include a communication interface that transmits/receives data to/from the network control system 1.

When the estimation calculator 11 receives a quality estimation request from the network control system 1, the estimation calculator 11 estimates a transmission quality of a target path specified in the request. Here, the estimation calculator 11 refers to the transmission quality database 14 and the intra-node OSNR value storage 15 and estimates the transmission quality of the target path.

The decision unit 12 decides whether the target path can be established according to the transmission quality of the target path that is estimated by the estimation calculator 11. In other words, when an estimated value of the transmission quality of the target path is better than a requested quality, the decision unit 12 decides that the target path can be established. On the other hand, when the estimated value of the transmission quality of the target path is worse than the requested quality, the decision unit 12 decides that the target path is not to be established. Then, a result of this decision is reported to the network control system 1. The update unit 13 updates the intra-node OSNR value stored in the intra-node OSNR value storage 15 according to a result of the calculation performed by the estimation calculator 11.

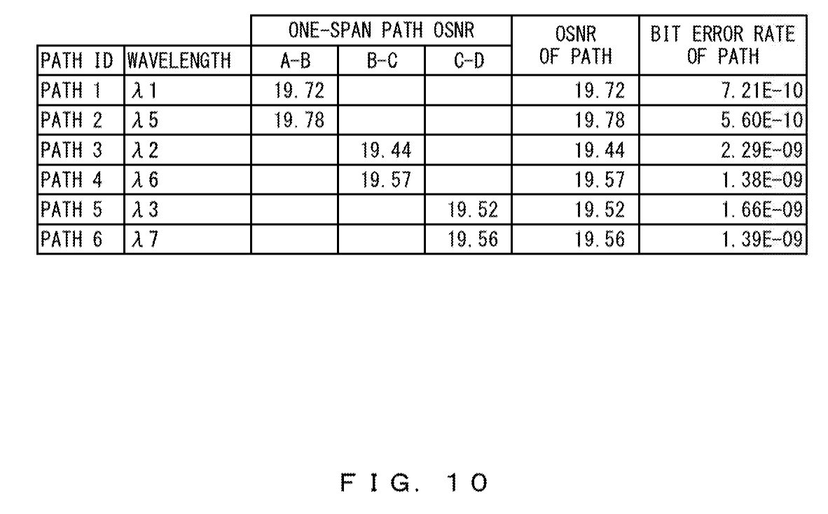

The transmission quality database 14 stores quality information for each wavelength path, as illustrated in FIG. 10. “PATH ID” identifies each wavelength path. “WAVELENGTH” represents a carrier wavelength of a wavelength path. “BIT ERROR RATE OF PATH” represents a measurement value of a bit error rate of a wavelength path. The bit error rate of a wavelength path is measured end-to-end. In other words, the bit error rate of a wavelength path is measured between a transmitter accommodated in a certain node and a receiver accommodated in another node. “OSNR OF PATH” represents an OSNR value calculated according to “BIT ERROR RATE OF PATH”. “ONE-SPAN PATH OSNR” represents an OSNR of a wavelength path for one span. In other words, the one-span path OSNR represents an OSNR value of a wavelength path configured by one Tx/Add section, one span section, and one Rx/Drop section. Thus, in a wavelength path established between adjacent nodes, “ONE-SPAN PATH OSNR” is equal to “PATH OSNR”, as illustrated in FIG. 10.

The intra-node OSNR value storage 15 stores an estimated value of an intra-node OSNR (OSNR_{adtr}). The intra-node OSNR represents the transmission quality of the Tx/Add section and the Rx/Drop section illustrated in FIG. 3. In the example illustrated in FIG. 4, the intra-node OSNR is calculated from a bit error rate measured by the measurement system illustrated in FIG. 5. On the other hand, the transmission quality estimation device 2 illustrated in FIG. 9 calculates and updates the intra-node OSNR every time a new wavelength path is established.

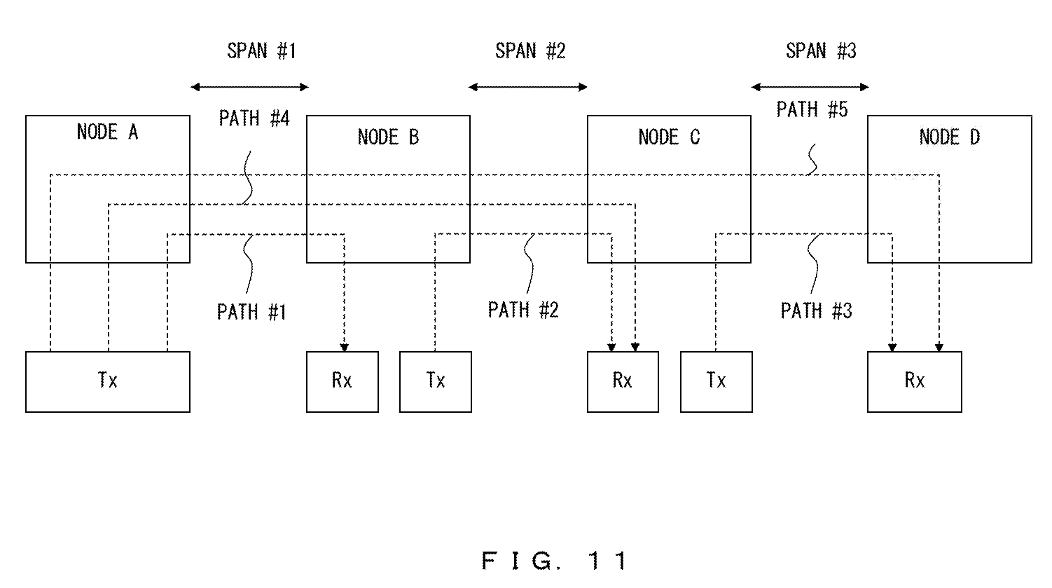

FIG. 11 illustrates an example of a method for calculating an intra-node OSNR. In this example, the wavelength path #1 is established between the nodes A and B, the wavelength path #2 is established between the nodes B and C, and the wavelength path #3 is established between the nodes C and D. In other words, each of the paths #1 to #3 is established between adjacent nodes. In this case, each of the OSNRs of the paths #1 to #3 is represented by Formula (10). For example, the OSNR of the path #1 is represented by the OSNR of a span #1 and the intra-node OSNR.

$$\frac{1}{{OSNR}_{Path 1}} = \frac{1}{{OSNR}_{SPAN 1}} + \frac{1}{{OSNR}_{adtr}} \\ \frac{1}{{OSNR}_{Path 2}} = \frac{1}{{OSNR}_{SPAN 2}} + \frac{1}{{OSNR}_{adtr}} \\ \frac{1}{{OSNR}_{Path 3}} = \frac{1}{{OSNR}_{SPAN 3}} + \frac{1}{{OSNR}_{adtr}} \qquad ( 10 )$$

A wavelength path #4 is established between the nodes A and C. The path #4 includes the span #1 and a span #2. Thus, the OSNR of the path #4 is represented by Formula (11). In other words, the OSNR of the path #4 is represented by the OSNR of the span #1, the OSNR of the span #2, and the intra-node OSNR.

$$\frac{1}{{OSNR}_{Path 4}} = \frac{1}{{OSNR}_{SPAN 1}} + \frac{1}{{OSNR}_{SPAN 2}} + \frac{1}{{OSNR}_{adtr}} \qquad ( 11 )$$

Thus, an estimated value of the intra-node OSNR (OSNR_{adtr}) is calculated using Formula (12)

$${OSNR}_{adtr} = \frac{1}{\frac{1}{{OSNR}_{Path 1}} + \frac{1}{{OSNR}_{Path 2}} - \frac{1}{{OSNR}_{Path 4}}} \qquad ( 12 )$$

The path #1 and the path #2 are respectively established between adjacent nodes, so the OSNR of the path #1 and the OSNR of the path #2 are respectively calculated from a measurement value of the bit error rate using Formula (4). Thus, if the OSNR of the path #4 is calculated from a measurement value of the bit error rate of the path #4, it will be possible to obtain an estimated value of the intra-node OSNR which corresponds to the path #4.

A wavelength path #5 is established between the nodes A and D. The path #5 includes the span #1, the span #2, and a span #3. Thus, the OSNR of the path #5 is represented by Formula (13). In other words, the OSNR of the path #5 is represented by the OSNR of the span #1, the OSNR of the span #2, the OSNR of the span #3, and the intra-node OSNR.

$$\frac{1}{{OSNR}_{Path 5}} = \frac{1}{{OSNR}_{SPAN 1}} + \frac{1}{{OSNR}_{SPAN 2}} + \frac{1}{{OSNR}_{SPAN 3}} + \frac{1}{{OSNR}_{adtr}} \qquad ( 13 )$$

Thus, an estimated value of the intra-node OSNR (OSNR_{adtr}) is calculated using Formula (14)

$${OSNR}_{adtr} = \frac{2}{\frac{1}{{OSNR}_{Path 1}} + \frac{1}{{OSNR}_{Path 2}} + \frac{1}{{OSNR}_{Path 3}} - \frac{1}{{OSNR}_{Path 5}}} \qquad ( 14 )$$

The paths #1 to #3 are respectively established between adjacent nodes, so the OSNRs of the paths #1 to #3 are respectively calculated from a measurement value of the bit error rate using Formula (4). Thus, if the OSNR of the path #5 is calculated from a measurement value of the bit error rate of the path #5, it will be possible to obtain an estimated value of the intra-node OSNR which corresponds to the path #5.

However, the path #5 includes three spans, so the sum of the OSNRs⁻¹ of the paths #1 to #3 includes three intra-node OSNRs sets. In other words, the OSNR⁻¹ of the path #5 is subtracted from the sum of the OSNRs⁻¹ of the paths #1 to #3, and two intra-node OSNRs sets are left. Thus, the numerator on the right side of Formula (14) is “2”.

As described above, in the transmission quality estimation device 2 illustrated in FIG. 9, an intra-node OSNR is calculated according to the bit error rate of a wavelength path. Here, there is also a variation in measurement value of the bit error rate of a wavelength path, as in the case of the bit error rate in a node device that is measured by the measurement system illustrated in FIG. 5. However, the bit error rate of a wavelength path is higher than the bit error rate in a node device. Thus, if measured in the same period of time, the accuracy of the bit error rate of a wavelength path will be higher than that of the bit error rate in a node device. In addition, in the transmission quality estimation device 2 illustrated in FIG. 9, the intra-node OSNR is averaged between those calculated in the past and calculated for a new wavelength path every time the transmission quality of a new wavelength path is estimated. Thus, an effect of the variation in bit error rate is further suppressed. As a result, an estimation accuracy will be improved if the transmission quality of a wavelength path is estimated using an updated intra-node OSNR.

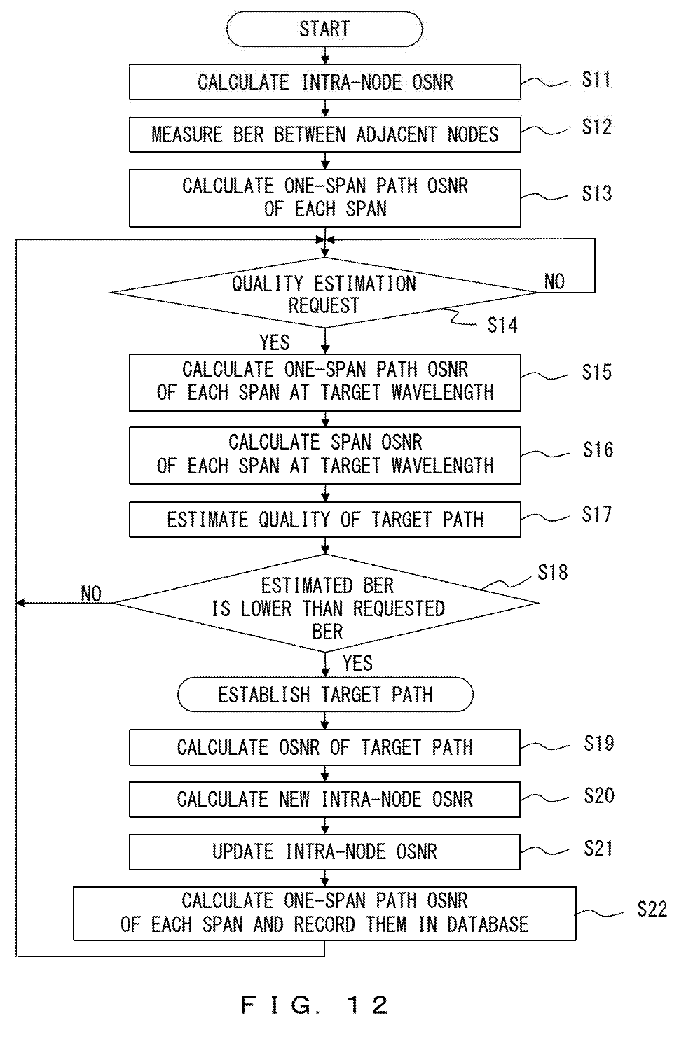

FIG. 12 is a flowchart that illustrates an example of the transmission quality estimation method according to the embodiments of the present invention. In this example, it is assumed that the optical transmission system that includes the nodes A to D illustrated in FIG. 1 is configured. Further, this optical transmission system is able to transmit a WDM optical signal between nodes. In other words, each of the nodes is provided with a WDM transmission device such as a ROADM.

S11-S13 are performed before the transmission quality estimation device 2 receives a quality estimation request. S11 and S12 are substantially the same as S1 and S2 of FIG. 4.

In S11, the estimation calculator 11 calculates an intra-node OSNR (that is, OSNR_{adtr}). In other words, a bit error rate is measured in any node device using the measurement system illustrated in FIG. 5. A result of this measurement is provided to the transmission quality estimation device 2. Then, the estimation calculator 11 calculates an intra-node OSNR from a measurement value of the bit error rate in the node device using Formula (4). Then, a result of this calculation is recorded in the intra-node OSNR value storage 15 as an initial value of the intra-node OSNR.

In S12, the network control system 1 measures a bit error rate of a wavelength path established between each set of adjacent nodes. For example, as illustrated in FIG. 6, the wavelength path 1 and the wavelength path 2 are established between the nodes A and B, the wavelength path 3 and the wavelength path 4 are established between the nodes B and C, and the wavelength path 5 and the wavelength path 6 are established between the nodes C and D. An optical signal is transmitted over each of the wavelength paths, and a bit error rate is measured in each reception-side node. A measurement result is collected by the network control system 1 and provided to the transmission quality estimation device 2. In the transmission quality estimation device 2, a measurement value of the bit error rate of each of the wavelength paths is recorded in the transmission quality database 14 illustrated in FIG. 10.

In S13, the estimation calculator 11 calculates an OSNR from the bit error rate of each of the wavelength paths using Formula (4). This OSNR corresponds to the OSNR of a wavelength path (that may hereinafter be referred to as a “path OSNR”). Further, the estimation calculator 11 calculates a one-span path OSNR of each span. Here, the “one-span path OSNR” represents a path OSNR that corresponds to one span in a target wavelength path. Thus, when a wavelength path is established between adjacent nodes, the “one-span path OSNR” is equal to the path OSNR. In other words, in this example, a one-span path OSNR of each span is obtained by converting the bit error rate of each wavelength path into an OSNR using Formula (4). Then, the OSNR of each wavelength path and the one-span path OSNR of each span are recorded in the transmission quality database 14 illustrated in FIG. 10.

In the example illustrated in FIG. 10, quality information on the wavelength paths 1 to 6 is recorded. For example, the wavelength path 1 is established between the nodes A and B, and its wavelength is λ1. The bit error rate measured for the wavelength path 1 is 7.21E-10. The path OSNR and the one-span path OSNR are calculated from an estimated value of the bit error rate. However, the wavelength path 1 is established between adjacent nodes (A and B), so the path OSNR and the one-span path OSNR are equal to each other.

In S14, the transmission quality estimation device 2 waits for a quality estimation request with respect to a new wavelength path. A demand for establishing a new wavelength path is provided to the network control system 1. In this case, the network control system 1 generates a quality estimation request according to the demand and transmits the request to the transmission quality estimation device 2. The quality estimation request specifies, for example, a start point node, an end point node, a route from the start point node to the end point node, and a wavelength of a wavelength path.

In this sample, it is assumed that the transmission quality estimation device 2 receives the following quality estimation request.

Start point: node A
End point: node D

### Route: A-B-C-D

### Wavelength: λ4

In the following descriptions, the wavelength path whose transmission quality is estimated according to the quality estimation request may be referred to as a “target path”. Further, the wavelength of the wavelength path whose transmission quality is estimated may be referred to as a “target wavelength”.

In S15, the estimation calculator 11 calculates a one-span path OSNR at a target wavelength for each span on a route on which the target path is established. In other words, the one-span path OSNR at the wavelength λ4 is calculated according to the one-span path OSNR recorded in the transmission quality database 14 illustrated in FIG. 10. For example, the one-span path OSNR at the wavelength λ4 between the nodes A and B is estimated by use of linear interpolation, using Formula (15). Each of the spans on a route on which the target path is established may be referred to as a “target span”.

$${EPOSNR}_{A - B} ( λ4 ) = \frac{{POSNR}_{A - B} ( λ1 ) - {POSNR}_{A - B} ( λ5 )}{λ 1 - λ 5} ( λ 4 - λ 5 ) + {POSNR}_{A - B} ( λ5 ) \qquad ( 15 )$$

EPOSNR_{A-B}(λ4) represents an estimated value of the one-span path OSNR at the wavelength λ4 between the nodes A and B. POSNR_{A-B}(λ1) represents the one-span path OSNR at the wavelength λ1 between the nodes A and B. POSNR_{A-B} (λ5) represents the one-span path OSNR at the wavelength λ5 between the nodes A and B. POSNR_{A-B}(λ1) and POSNR_{A-B}(λ5) are recorded in the transmission quality database 14.

Similarly, the estimation calculator 11 estimates the one-span path OSNR at the wavelength λ4 between the nodes B and c (EPOSNR_{B-C}(λ4)) and the one-span path OSNR at the wavelength λ4 between the nodes C and D (EPOSNR_{C-D}(λ4)).

In S16, the estimation calculator 11 calculates a span OSNR at the target wavelength for each span on a route on which the target path is established. The span OSNR is calculated according to a one-span path OSNR and an intra-node OSNR. Specifically, the span OSNR is obtained by eliminating an effect of the intra-node OSNR from the one-span path OSNR. For example, the span OSNR at the wavelength λ4 between the nodes A and B is calculated using Formula (16).

$${SOSNR}_{A - B} ( λ4 ) = \frac{1}{\frac{1}{{EPOSNR}_{A - B} ( λ4 )} - \frac{1}{{OSNR}_{adtr}}} \qquad ( 16 )$$

SOSNR_{A-B} (λ4) represents an estimated value of the span OSNR at the wavelength λ4 between the nodes A and B. OSNR_{adtr} represents an intra-node OSNR value stored in the intra-node OSNR value storage 15. Here, in the quality estimation of the first wavelength path, the intra-node OSNR initial value calculated in S11 is used as the intra-node OSNR value. However, the intra-node OSNR value is updated in S21 every time a new wavelength path is established. Thus, in the quality estimations of subsequent wavelength paths, the intra-node OSNR value updated according to the bit error rate of a most recently established wavelength path is used as the intra-node OSNR value.

Similarly, the estimation calculator 11 estimates the span OSNR at the wavelength λ4 between the nodes B and C (SOSNR_{B-C}(λ4)) and the span OSNR at the wavelength λ4 between the nodes C and D (SOSNR_{C-D}(λ4)).

In S17, the estimation calculator 11 estimates the OSNR of the target path using Formula (17). In this example, the path OSNR of the wavelength path 7 over which an optical signal is transmitted from the transmitter 17 of the node A to the receiver 16 of the node D is estimated.

$${EPOSNR}_{A - D} ( λ4 ) = \frac{1}{\begin{matrix}\frac{1}{{SOSNR}_{A - B} ( λ4 )} + \frac{1}{{SOSNR}_{B - C} ( λ4 )} + \\ \frac{1}{{SOSNR}_{C - D} ( λ4 )} + \frac{1}{{OSNR}_{adtr}}\end{matrix}} \qquad ( 17 )$$

EPOSNR_{A-D}(λ4) represents an estimated value of an OSNR of a wavelength path over which an optical signal is transmitted from the transmitter 17 of the node A to the receiver 16 of the node D. In the quality estimation of the first wavelength path, the intra-node OSNR initial value calculated in S11 is used as the intra-node OSNR value. On the other hand, in the quality estimations of subsequent wavelength paths, the intra-node OSNR value updated according to the bit error rate of a most recently established wavelength path is used as the intra-node OSNR value.

Further, the estimation calculator 11 calculates a bit error rate from the OSNR of the target path using Formula (18). In this example, it is assumed that the bit rate is 100 Gbps and a polarization-multiplexed QPSK-modulated optical signal is transmitted.

$${EPBER}_{A - D} ( λ 4 ) = \frac{1}{2} erfc ( \sqrt{\frac{{EPOSNR}_{A - D} ( λ4 ) \cdot Bn}{2 Rs}} ) \qquad ( 18 )$$

EPBER_{A-D}(λ4) represents an estimate bit error rate of a wavelength path over which an optical signal is transmitted from the transmitter 17 of the node A to the receiver 16 of the node D. Rs represents a baud rate of the signal. Bn represents a noise bandwidth.

In S18, the decision unit 12 compares the transmission quality estimated in S17 and a specified threshold. In this example, the estimated bit error rate calculated in Formula (18) and a requested bit error rate are compared. The requested bit error rate is specified by a user or a network administrator. Then, when the estimated bit error rate is lower than the requested bit error rate, the decision unit 12 decides that the target path can be established. On the other hand, when the estimated bit error rate is higher than the requested bit error rate, the decision unit 12 decides that the target path is not to be established. A result of this decision is reported from the transmission quality estimation device 2 to the network control system 1.

When the network control system 1 receives a decision result indicating “possible to establish” from the transmission quality estimation device 2, the network control system 1 establishes the target path in an optical network. Further, the network control system 1 measures a bit error rate of the established target path and reports the measurement result to the transmission quality estimation device 2.

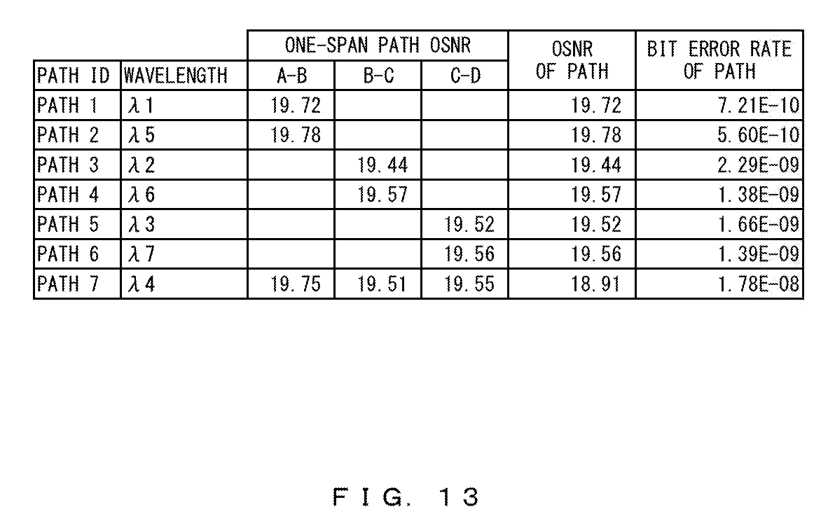

In S19, the estimation calculator 11 records a measurement value of the bit error rate of the target path in the transmission quality database 14. In the example illustrated in FIG. 13, the bit error rate of the target path is 1.78E-08. In FIG. 13, the target path is notated as “PATH 7”.

Further, the estimation calculator 11 calculates the OSNR of the target path from the measurement value of the bit error rate of the target path using Formula (19).

$${MPOSNR}_{A - D} ( λ4 ) = {( {erfc}^{- 1} ( 2 {MPBER}_{A - D} ( λ4 ) ) )}^{2} \cdot \frac{2 Rs}{Bn} \qquad ( 19 )$$

MPBER_{A-D}(λ4) represents a measurement value of a bit error rate of a target path established between the nodes A and D. MPOSNR_{A-D}(λ4) represents an OSNR of the target path that is calculated from the measurement value of the bit error rate of the target path. Then, the estimation calculator 11 records the OSNR of the target path (that is, MPOSNR_{A-D}(λ4)) in the transmission quality database 14.

In S20, the estimation calculator 11 calculates an intra-node OSNR that corresponds to the target path according to the one-span path OSNR at a target wavelength for each span and the OSNR of the target path, wherein the one-span path OSNR at a target wavelength for each span is obtained in S15 and the OSNR of the target path is obtained in S19. Specifically, a new intra-node OSNR is calculated using Formula (20).

$${EOSNR}_{adtr} = \frac{2}{\begin{matrix}\frac{1}{{EPOSNR}_{A - B} ( λ4 )} + \frac{1}{{EPOSNR}_{B - C} ( λ4 )} + \\ \frac{1}{{EPOSNR}_{C - D} ( λ4 )} - \frac{1}{{MPOSNR}_{A - D} ( λ4 )}\end{matrix}} \qquad ( 20 )$$

EOSNR_{adtr} represents an intra-node OSNR estimated using an OSNR of a newly established wavelength path.

In S21, the update unit 13 updates the intra-node OSNR stored in the intra-node OSNR value storage 15 using a new intra-node OSNR value obtained in S20. As an example, the update unit 13 updates the intra-node OSNR value using Formula (21).

OSNR_{adtr}_{_}_{new}=γEOSNR_{adtr}+(1−γ)OSNR_{adtr}_{_}_{old} (21)

OSNR_{adtr}_{_}_{old} represents an intra-node OSNR value stored in the intra-node OSNR value storage 15. OSNR_{adtr}_{_}_{new} represents an intra-node OSNR value on which updating has been performed by the update unit 13. γ represents an averaging coefficient. The coefficient γ is a real number that is greater than zero and less than one. If the coefficient γ is too large, an effect of a measurement value of the bit error rate at a most newly established wavelength path will be strong. Thus, it is preferable that the coefficient γ be a value close to zero.

In S22, the estimation calculator 11 calculates a one-span path OSNR for each span on a route of the target path. Specifically, the estimation calculator 11 calculates a difference between a measurement value of the transmission quality of a newly established wavelength path and an estimated value of the transmission quality of this wavelength path. The measurement value of the transmission quality of the target path is calculated in S19 using Formula (19). The estimated value of the transmission quality of the target path is calculated in S17 using Formula (17). Then, the estimation calculator 11 calculates a one-span path OSNR by correcting, with the above difference, the sum of the span OSNR value of the target span and a new intra-node OSNR value, wherein the span OSNR value of the target span is calculated in S16 using Formula (16) and the new intra-node OSNR value is calculated in S21 using Formula (21). For example, the one-span path OSNR between the nodes A and B is calculated using Formula (22).

$${POSNR}_{A - B} ( λ4 ) = \frac{1}{\frac{1}{{EPOSNR}_{A - B} ( λ4 )} + \frac{1}{{OSNR}_{adtr \_ new}} + α ( x - y )} \\ x = \frac{1}{{POSNR}_{A - D} ( λ4 )} - \frac{1}{{OSNR}_{adtr \_ new}} \\ y = \frac{1}{{EPOSNR}_{A - D} ( λ4 )} - \frac{1}{{OSNR}_{adtr \_ old}} \qquad ( 22 )$$

POSNR_{A-B}(λ4) represents a one-span path OSNR at the wavelength λ4 between the nodes A and B. A coefficient α represents a proportion of an OSNR value between the nodes A and B to an OSNR value of the entirety of the target path. x corresponds to a measurement value of the transmission quality of a span-section portion in the target path. y corresponds to an estimated value of the transmission quality of the span-section portion in the target path. Thus, x-y represents a difference between the measurement value and the estimated value.

The one-span path OSNRs are also respectively calculated for the span between the nodes B and C and for the span between the nodes C and D. However, the coefficient α is determined by, for example, simulation for each span according to, for example, the features and the length of an optical-fiber link. Then, the one-span path OSNRs of the spans are added to the transmission quality database 14 for each span, as illustrated in FIG. 13.

After that, the process of the transmission quality estimation device 2 returns to S14. In other words, the transmission quality estimation device 2 waits for a next quality estimation request. Then, when the next quality estimation request is provided, the transmission quality estimation device 2 estimates a transmission quality of a new wavelength path using a newest transmission quality database 14 and the updated intra-node OSNR value.

As described above, in the transmission quality estimation method according to the embodiments of the present invention, the intra-node OSNR that represents a transmission quality in a node device is updated every time a new wavelength path is established. Here, a newest intra-node OSNR value is obtained by averaging the intra-node OSNR value between intra-node OSNR values calculated using a wavelength path established in the past and an intra-node OSNR value calculated using a newly established wavelength path. Thus, with an increase in the number of established wavelength paths, the accuracy of an intra-node OSNR value is improved and the estimation accuracy of a transmission quality of a wavelength path is also improved.

<Hardware Configuration>

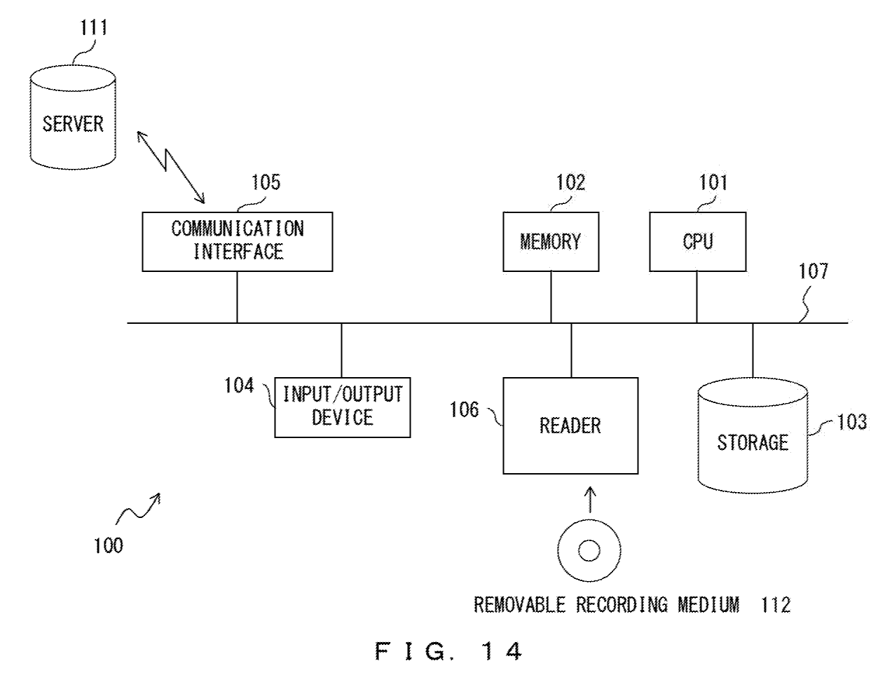

FIG. 14 illustrates an example of a hardware configuration of the transmission quality estimation device 2. The transmission quality estimation device 2 is implemented by, for example, a computer system 100 illustrated in FIG. 14. The computer system 100 includes a CPU 101, a memory 102, a storage 103, an input/output device 104, a communication interface 105, and a reader 106. The CPU 101, the memory 102, the storage 103, the input/output device 104, the communication interface 105, and the reader 106 are connected to, for example, a bus 107.

Using the memory 102, the CPU 101 executes a program in which the processing of the flowchart illustrated in FIG. 12 is described. By doing this, the transmission quality estimation method described above is implemented. In other words, the CPU 101 can provide functions as the estimation calculator 11, the decision unit 12, and the update unit 13 illustrated in FIG. 9. The memory 102 is, for example, a semiconductor memory, and is configured to include a RAM area and a ROM area. The storage 103 is, for example, a hard disk, and stores the program described above. The storage 103 may be a semiconductor memory such as a flash memory. The storage 103 may be an external storage. The transmission quality database 14 and the intra-node OSNR value storage 15 illustrated in FIG. 9 may be configured using the memory 102 or the storage 103.

The input/output device 104 corresponds to, for example, a keyboard, a mouse, and a touch panel that are manipulated by a user. A result of measuring a transmission quality may be provided by the user to the CPU 101 via the input/output device 104. Further, the input/output device 104 outputs a result of processing performed by the CPU 101.

The communication interface 105 is able to transmit and receive data via a network according to an instruction issued by the CPU 101. In other words, the communication interface 105 is able to transmit/receive data to/from the network control system 1. Further, the communication interface 105 is able to access a server 111 implemented in the network. The reader 106 accesses a removable recording medium 112 according to an instruction issued by the CPU 101. For example, the removable recording medium 112 is implemented by a semiconductor device (such as a USB memory), a medium to/from which information is input/output by magnetic action (such as a magnetic disk), and a medium to/from which information is input/output by optical action (such as a CD-ROM and a DVD).

The program of the embodiments is provided to the computer system 100, for example, in the following state:

(1) Preinstalled in the storage 103
(2) Provided by the removable recording medium 112
(3) Provided from the server 111

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present inventions have been described in detail, it should be understood that the various changes, substitutions, and alterations could be made hereto without departing from the spirit and scope of the invention.

What is claimed is:

1. A transmission quality estimation method that estimates a transmission quality of a target path, the method comprising:
storing path transmission quality values that respectively indicate transmission qualities of paths established between adjacent nodes in a first storage;
storing a node transmission quality value that indicates a transmission quality of a node device in a second storage;
estimating a transmission quality of the target path based on the path transmission quality values stored in the first storage and the node transmission quality value stored in the second storage;
calculating a node transmission quality value based on the estimated transmission quality of the target path; and
updating the node transmission quality value stored in the second storage using the calculated node transmission quality value.

2. The transmission quality estimation method according to claim 1, wherein
the node transmission quality value stored in the second storage is updated by adding a result of multiplying a node transmission quality value corresponding to the target path by γ to a result of multiplying the node transmission quality value stored in the second storage by 1−γ, where γ is a real number that is greater than zero and less than one.

3. A transmission quality estimation method that estimates a transmission quality of a target path in a wavelength division multiplexing optical transmission system, the method comprising:
storing path transmission quality values that respectively indicate transmission qualities of paths established between adjacent nodes in a first storage;
storing an intra-node transmission quality value that indicates a transmission quality in a node device in a second storage;
calculating a one-span path transmission quality value that indicates a path transmission quality at a wavelength of a target path based on corresponding path transmission quality values stored in the first storage with respect to a target span on a route on which the target path is established;
estimating a transmission quality of the target path based on the one-span path transmission quality value calculated with respect to the target span and the intra-node transmission quality value stored in the second storage;
obtaining a measurement value of a transmission quality of the target path;
calculating a new intra-node transmission quality value corresponding to the target path based on the target path transmission quality value calculated with respect to the target span and the measurement value of the transmission quality of the target path; and
updating the intra-node transmission quality value stored in the second storage using the new intra-node transmission quality value.

4. The transmission quality estimation method according to claim 3, further comprising:
correcting the one-span path transmission quality value calculated for the target span according to a difference between an estimated value of the transmission quality of the target path and the measurement value of the transmission quality of the target path, and
storing the corrected one-span path transmission quality value in the first storage.

5. A transmission quality estimation device that estimates a transmission quality of a target path, the device comprising:
a first storage configured to store path transmission quality values that respectively indicate transmission qualities of paths established between adjacent nodes;
a second storage configured to store a node transmission quality value that indicates a transmission quality of a node device;
an estimation calculator configured to estimate a transmission quality of the target path based on the path transmission quality values stored in the first storage and the node transmission quality value stored in the second storage and to calculate a node transmission quality value based on the estimated transmission quality of the target path; and
an update unit configured to update the node transmission quality value stored in the second storage using the node transmission quality value calculated by the estimation calculator.
